(19) United States
(12) Patent Application Publication
(10) Pub. No.: US 2024/0329427 A1
(43) Pub. Date: Oct. 3, 2024

(54) FRAME

(71) Applicant: Apple Inc., Cupertino, CA (US)

(72) Inventors: Colin P. WESTEINDE, San Francisco, CA (US); Phil M. HOBSON, Menlo Park, CA (US); Julian JAEDE, San Francisco, CA (US)

(21) Appl. No.: 18/579,844

(22) PCT Filed: Jul. 12, 2022
(86) PCT No.: PCT/US2022/036859

§ 371 Date: Jan. 16, 2024

Related U.S. Application Data
(60) Provisional application No. 63/222,906, filed on Jul. 16, 2021.

(51) Int. Cl. G02C 1/06; G02B 27/01; G02C 11/00

(52) U.S. Cl. CPC G02C 1/06; G02B 27/0176; G02C 11/10; G02B 2027/0178

(57) ABSTRACT

A frame can support components of a head-mountable device. The frame can include a frame body that is curved to fit a user's face. The frame body can include a forehead body portion, an orbital body portion, and a bridge body portion. Each body portion can have a cross-sectional profile that has an outer curvature. The outer curvature of each of the cross-sectional profiles can be difference. Further, the frame body can transition in profile between the different cross-sectional profiles.

### CROSS-REFERENCE TO RELATED APPLICATION

This application claims the benefit of U.S. Provisional Application No. 63/222,906, entitled “FRAME FOR HEAD-MOUNTABLE DEVICE,” filed Jul. 16, 2021, the entirety of which is hereby incorporated herein by reference.

### TECHNICAL FIELD

The present description relates generally to head-mountable devices, and, more particularly, to a frame for supporting a head-mountable devices.

### BACKGROUND

A head-mountable device can be worn by a user to display visual information within the field of view of the user. The head-mountable device can be used as a virtual reality (VR) system, an augmented reality (AR) system, and/or a mixed reality (MR) system. A user may observe outputs provided by the head-mountable device, such as visual information provided on a display. The display can optionally allow a user to observe an environment outside of the head-mountable device. Other outputs provided by the head-mountable device can include speaker output and/or haptic feedback. A user may further interact with the head-mountable device by providing inputs for processing by one or more components of the head-mountable device. For example, the user can provide tactile inputs, voice commands, and other inputs while the device is mounted to the user's head.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates a perspective view of a user wearing a head-mountable device, according to some embodiments of the present disclosure.

FIG. 2 illustrates a perspective view of a frame of the head-mountable device of FIG. 1 shown in context of the user.

FIG. 3 illustrates an x-y plane of a frame of the head-mountable device of FIG. 1.

FIG. 4 illustrates a cross-sectional view of the frame of FIG. 3 along section lines 4-4.

FIG. 5 illustrates a cross-sectional view of the frame of FIG. 3 along section lines 5-5.

FIG. 6 illustrates a cross-sectional view of the frame of FIG. 3 along section lines 6-6.

FIG. 7 illustrates an x-z plane of a frame of the head-mountable device of FIG. 1.

FIG. 8 illustrates an y-z plane of a frame of the head-mountable device of FIG. 1.

FIG. 9 illustrates a perspective view of a frame of the head-mountable device of FIG. 1.

FIG. 10 shows a simplified block diagram of an illustrative head-mountable device, according to some embodiments of the present disclosure

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Head-mountable devices, such as head-mountable displays, headsets, visors, smartglasses, head-up display, etc., can perform a range of functions that are managed by the components (e.g., sensors, circuitry, and other hardware) included with the wearable device.

The components of the head-mountable device are supported by a frame. The frame can be shaped to comfortably fit against the face of a user. It can be desirable to maximize the fit and comfort on the user, so that usage of the head-mountable device for extended durations is not difficult for the user. In some applications, certain portions of the frame can have different shapes or cross-sectional profiles. Further, it can be desirable to provide a frame that is aesthetically pleasing to the user and smoothly transitions between the different portions of the frame

However, in some applications, certain frames can formed by complex machining processes that are time consuming, require multiple process steps, or may result in undesirable features or transitions between features.

It can be desirable to provide a frame that provides different shapes or cross-sectional profiles and smoothly transitions between the different portions. Further, it can be desirable to provide a frame that manufactured in a simplified process that still provides a desired frame design. For example, embodiments of the present disclosure can provide a frame that supports components of a head-mountable device. The frame can include a frame body that is curved to fit a user's face. The frame body can include a forehead body portion, an orbital portion, and a bridge portion. Each body portion can have a cross-sectional profile that has an outer curvature. The outer curvature of each of the cross-sectional profiles can be different. Further, the frame body can transition in profile between the different cross-sectional profiles.

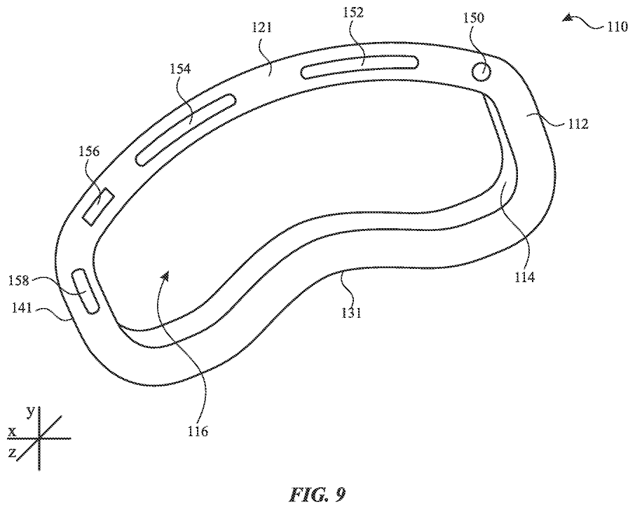

These and other embodiments are discussed below with reference to FIGS. 1-10. However, those skilled in the art will readily appreciate that the detailed description given herein with respect to these Figures is for explanatory purposes only and should not be construed as limiting.

According to some embodiments, for example as shown in FIG. 1, a head-mountable device 10 includes an HMD assembly 100. The HMD assembly 100 includes a frame 110 that is worn on a head of a user 1. The frame 110 can be positioned in front of the eyes of a user 1 to provide information within a field of view of the user 1. The HMD assembly 100 can provide a nosepiece to rest on a user's nose or bridge 4.

As described herein, the frame 110 can provide structure around a peripheral region thereof to support any internal components of the frame 110 in their assembled position. For example, the frame 110 can enclose and support various internal components (including for example integrated circuit chips, processors, memory devices and other circuitry) to provide computing and functional operations for the head-mountable device 10, as discussed further herein. While several components are shown within the frame 110, it will be understood that some or all of these components can be located anywhere within or on the head-mountable device 10.

The frame 110 can include and/or support one or more cameras 130. The cameras 130 can be positioned on or near an outer side of the head-mountable device 10 to capture images of views external to the head-mountable device 10. As used herein, an outer side of a portion of a head-mountable device is a side that faces away from the user and/or towards an external environment. The captured images can be used for display to the user 1 or stored for any other purpose. Each of the cameras 130 can be movable along the outer side. For example, a track or other guide can be provided for facilitating movement of the camera 130 therein.

The head-mountable device 10 can include displays 140 that provide visual output for viewing by a user 1 wearing the head-mountable device 10. One or more displays 140 can be positioned on or near an inner side of the head-mountable device 10. As used herein, an inner side of a portion of a head-mountable device is a side that faces toward the user and/or away from the external environment.

A display 140 can transmit light from a physical environment (e.g., as captured by a camera) for viewing by the user 1. Such a display 140 can include optical properties, such as lenses for vision correction based on incoming light from the physical environment. Additionally or alternatively, a display 140 can provide information as a display within a field of view of the user 1. Such information can be provided to the exclusion of a view of a physical environment or in addition to (e.g., overlaid with) a physical environment.

A physical environment relates to a physical world that people can sense and/or interact with without necessarily requiring the aid of an electronic device. A computer-generated reality environment relates to a wholly or partially simulated environment that people sense and/or interact with the assistance of an electronic device. Examples of computer-generated reality include mixed reality and virtual reality. Examples of mixed realities can include augmented reality and augmented virtuality. Some examples of electronic devices that enable a person to sense and/or interact with various computer-generated reality environments include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable device can have an integrated opaque display, have a transparent or translucent display, or be configured to accept an external opaque display (e.g., smartphone).

Each display 140 can be adjusted to align with a corresponding eye of the user 1. For example, each display 140 can be moved along one or more axes until a center of each display 140 is aligned with a center of the corresponding eye. Accordingly, the distance between the displays 140 can be set based on an interpupillary distance (“IPD”) of the user. IPD is defined as the distance between the centers of the pupils of a user's eyes.

The pair of displays 140 can be mounted to the frame 110 and separated by a distance. The distance between the pair of displays 140 can be designed to correspond to the IPD of a user 1. The distance can be adjustable to account for different IPDs of different users that may wear the head-mountable device 10. For example, either or both of the displays 140 may be movably mounted to the frame 110 to permit the displays 140 to move or translate laterally to make the distance larger or smaller. Any type of manual or automatic mechanism may be used to permit the distance between the displays 140 to be an adjustable distance. For example, the displays 140 can be mounted to the frame 110 via slidable tracks or guides that permit manual or electronically actuated movement of one or more of the displays 140 to adjust the distance there between.

Additionally or alternatively, the displays 140 can be moved to a target location based on a desired visual effect that corresponds to user's perception of the display 140 when it is positioned at the target location. The target location can be determined based on a focal length of the user and/or optical elements of the system. For example, the user's eye and/or optical elements of the system can determine how the visual output of the display 140 will be perceived by the user. The distance between the display 140 and the user's eye and/or the distance between the display 140 and one or more optical elements can be altered to place the display 140 at, within, or outside of a corresponding focal distance. Such adjustments can be useful to accommodate a particular user's eye, corrective lenses, and/or a desired optical effect.

As described herein, the HMD assembly 100 can further include a processor or controller 178 to provide a visual output signal to the displays 140. Further, the HMD assembly 100 can include a speaker 194 and/or a microphone 188 to receive and/or provide an audio signal, respectively. The controller 178 can provide and/or receive the audio signal to the speaker 194 and/or the microphone 188, respectively. Among the other components described herein, the controller 178, the speaker 194, and the microphone 188 can be supported by the frame 110.

The HMD assembly 100 and/or the frame 110 can be supported on a user's head with a head engager 102. The head engager 102 can extend from the frame 110 and wrap or extend along opposing sides of a user's head and/or to a rear of the user's head.

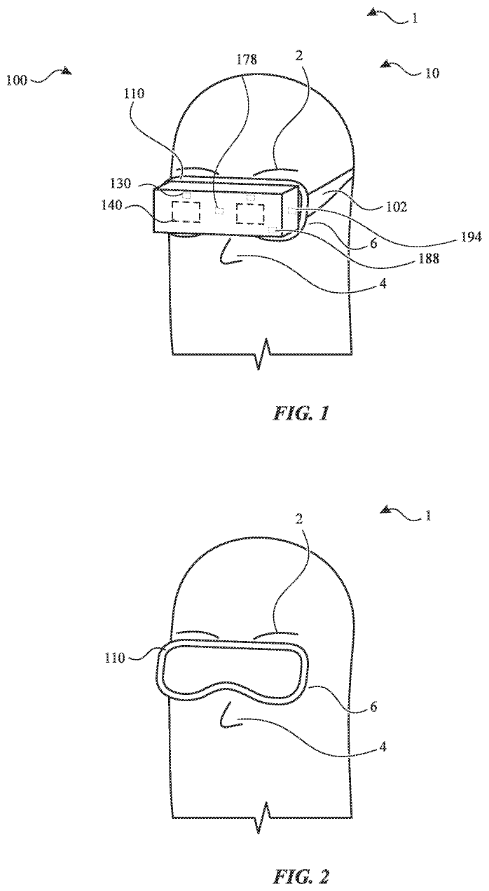

With reference to FIG. 2, the frame 110 of the head-mountable device 10 allows the displays 140 to be shown to the user 1 in a comfortable manner. As described herein, the body of the frame 110 can be curved or otherwise shaped in multiple planes to allow the frame 110 to conform to the shape of a user's face. In some embodiments, the frame 110 can have frame curvature in three perpendicular planes.

Further, different portions of the frame 110 can have different shapes or cross-sectional profiles to allow the frame to conform to the shape of the user's face. As used herein, a cross-sectional profile refers to a feature of a structure that is defined in a cross section thereof. A cross-sectional profile can be defined by a shape, size, dimension, diameter, thickness, width, and the like as measured or otherwise determined within a cross section of the structure. For example, the shape or cross-sectional profile of a portion of the frame 110 near the brow 2 of the user 1 can be shaped to allow for user comfort and alignment of the displays 140. Similarly, the shape or cross-sectional profile of a portion of the frame 110 near the nose or bridge 4 of the user 1 can be shaped to allow for user comfort and alignment of the displays 140. Further, the shape or cross-sectional profile of a portion of the frame 110 near the cheeks or orbit 6 of the user 1 can be shaped to allow for user comfort and alignment of the displays 140.

In some embodiments, the body of the frame 110 can smoothly transition in shape from the various portions of the frame 110, allowing for a continuously changing shape between the various points of the frame 110. Advantageously, the smooth transition in shape or cross-sectional profile can allow for an aesthetically pleasing design.

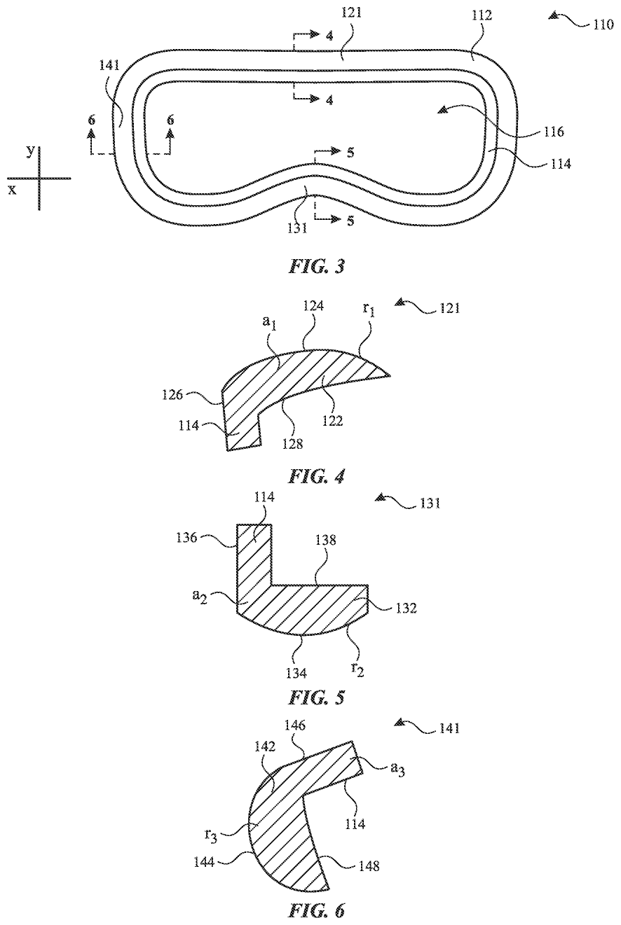

With reference to FIG. 3, a view of the frame 110 in the x-y plane is shown. As illustrated, the frame body 112 is curved or otherwise shaped in the x-y plane to allow for the frame 110 to conform to the shape of the user's face. In other words, the frame body 112 (instead of the cross-sectional profile of the frame body 112) can have frame curvature in the x-y plane. In the depicted example, the frame body 112 forms a closed loop in the x-y plane defining an opening 116 therein. The opening 116 can be configured to generally correspond to the position of the user's eyes. The displays 140 and other components of the head-mountable device 10 can be mounted within the opening 116. A lip portion 114 can extend from the frame body 112 in toward the opening 116.

The closed loop of frame body 112 can define a “racetrack” or “FIG. 8” shape in the x-y plane to conform to the facial features of the user. Further, the closed loop of the frame body 112 can include or define various portions of the frame body 112 that are adjacent to, or otherwise designed to conform to various portions of the user's face.

For example, a forehead or brow portion 121 of the frame body 112 can be shaped, curved, or otherwise configured to engage with, conform to, or otherwise correspond to the anatomical features of the user's forehead or brow 2. As described herein, the cross-sectional profile of the brow portion 121, as shown in FIG. 4 can be shaped to correspond to the anatomical features of the user's forehead or brow. Further, a nose or bridge portion 131 of the frame body 112 can be shaped, curved, or otherwise configured to engage with, conform to, or otherwise correspond to the anatomical features of the user's nose or bridge 4. It will be understood that the bridge portion 131 can be or include one or both of a first bridge portion and a second bridge portion that are opposite each other. As described herein, the cross-sectional profile of the bridge portion 131, as shown in FIG. 5 can be shaped to correspond to the anatomical features of the user's nose or bridge. Similarly, a cheek or orbital portion 141 of the frame body 112 can be shaped, curved, or otherwise configured to engage with, conform to, or otherwise correspond to the anatomical features of the user's cheeks or orbits 6. It will be understood that the orbital portion 141 can be or include one or both of a first orbital portion and a second orbital portion that are opposite each other. Each of the bridge portion(s) can extend from the orbital portion(s) 141 (i.e., from ends thereof), and the forehead portion 121 can extend between the orbital portion(s) 141 (i.e., from other ends thereof). As described herein, the cross-sectional profile of the orbital portion 141, as shown in FIG. 6 can be shaped to correspond to the anatomical features of the user's cheeks or orbitals.

FIG. 4 illustrates a cross-sectional view of the brow portion 121 of the frame body 112 along section lines 4-4. The cross-sectional profile 122 of the brow portion 121 is shaped to conform to a user's brow 2. In some embodiments, the cross-sectional profile 122 can further be defined by the lip portion 114. As illustrated, the brow portion 121 extends from the lip portion 114.

In the depicted example, the brow portion 121 and the lip portion 114 cooperatively define an end portion 126 of the cross-sectional profile 122. The end portion 126 can be a flat, straight, or otherwise linear section of the cross-sectional profile 122. Optionally, the end portion 126 can have a curvature.

Further, the brow portion 121 and the lip portion 114 cooperatively define an inner portion 128 of the cross-sectional profile 122. The inner portion 128 is the portion of the cross-sectional profile 122 that is adjacent to the opening 116 defined by the frame body 112. The inner portion 128 generally extends away from the lip portion 114. The inner portion 128 can be a curved section of the cross-sectional profile 122. Optionally, the inner portion 128 can be a linear section of the cross-sectional profile 122.

In the depicted example, the brow portion 121 defines an outer portion 124. The outer portion 124 is the portion of the cross-sectional profile 122 that is opposite to the opening 116 defined by the frame body 112. Similar to the inner portion 128, the outer portion 124 extends away from the lip portion 114. As illustrated, the outer portion 124 is a curved section of the cross-sectional profile 122. In the depicted example, the curvature of the outer portion 124 of the cross-sectional profile 122 can be referred to as outer curvature, which is distinguished from the frame curvature that is shown with respect to the x-y, x-z, and y-z planes. The outer portion 124 can be an arc or portion of a circular curve having a radius r1. In some embodiments, the outer portion 124 can include or define a simple curve, a compound curve, a transitional curve, and/or a reverse curve.

As illustrated, the various portions of the cross-sectional profile 122 can define an overall shape for the cross-sectional profile 122 that corresponds to the user's forehead or brow. The cross-sectional profile 122 can have a defined area a1.

FIG. 5 illustrates a cross-sectional view of the bridge portion 131 of the frame body 112 along section lines 5-5. The cross-sectional profile 132 of the bridge portion 131 is shaped to conform to a user's bridge 4. In some embodiments, the cross-sectional profile 132 can further be defined by the lip portion 114. As illustrated, the bridge portion 131 extends from the lip portion 114.

In the depicted example, the bridge portion 131 and the lip portion 114 cooperatively define an end portion 136 of the cross-sectional profile 132. The end portion 136 can be a flat, straight, or otherwise linear section of the cross-sectional profile 132. Optionally, the end portion 136 can have a curvature.

Further, the bridge portion 131 and the lip portion 114 cooperatively define an inner portion 138 of the cross-sectional profile 132. The inner portion 138 is the portion of the cross-sectional profile 132 that is adjacent to the opening 116 defined by the frame body 112. The inner portion 138 generally extends away from the lip portion 114. The inner portion 138 can be a linear section of the cross-sectional profile 132. Optionally, the inner portion 138 can be a curved section of the cross-sectional profile 132.

In the depicted example, the bridge portion 131 defines an outer portion 134. The outer portion 134 is the portion of the cross-sectional profile 132 that is opposite to the opening 116 defined by the frame body 112. Similar to the inner portion 138, the outer portion 134 extends away from the lip portion 114. As illustrated, the outer portion 134 is a curved section of the cross-sectional profile 132. Similarly, the curvature of the outer portion 134 of the cross-sectional profile 132 can be referred to as outer curvature, which is distinguished from the frame curvature that is shown with respect to the x-y, x-z, and y-z planes. The outer portion 134 can be an arc or portion of a circular curve having a radius r2. In the depicted example, the radius r2 of the outer portion 134 is different than the radius r1 of the outer portion 124. In some embodiments, the radius r2 of the outer portion 134 is smaller than the radius r1 of the outer portion 124. In some embodiments, the outer portion 134 can include or define a simple curve, a compound curve, a transitional curve, and/or a reverse curve. In some embodiments, the curvature of the outer portion 134 is different than the curvature of the outer portion 124.

As illustrated, the various portions of the cross-sectional profile 132 can define an overall shape for the cross-sectional profile 132 that corresponds to the user's nose or bridge. The overall shape of the cross-sectional profile 132 can be different than the overall shape of the cross-sectional profile 122. The cross-sectional profile 132 can have a defined area a2. In the depicted example, the area a2 of the cross-sectional profile 132 is different than the area a1 of the cross-sectional profile 122. For example, the area a2 of the cross-sectional profile 132 is smaller than the area a1 of the cross-sectional profile 122.

FIG. 6 illustrates a cross-sectional view of the orbital portion 141 of the frame body 112 along section lines 6-6. The cross-sectional profile 142 of the orbital portion 141 is shaped to conform to a user's cheek or orbit 6. In some embodiments, the cross-sectional profile 142 can further be defined by the lip portion 114. As illustrated, the orbital portion 141 extends from the lip portion 114.

In the depicted example, the orbital portion 141 and the lip portion 114 cooperatively define an end portion 146 of the cross-sectional profile 142. The end portion 146 can be a flat, straight, or otherwise linear section of the cross-sectional profile 142. Optionally, the end portion 146 can have a curvature.

Further, the orbital portion 141 and the lip portion 114 cooperatively define an inner portion 148 of the cross-sectional profile 142. The inner portion 148 is the portion of the cross-sectional profile 142 that is adjacent to the opening 116 defined by the frame body 112. The inner portion 148 generally extends away from the lip portion 114. The inner portion 148 can be a linear section of the cross-sectional profile 142. Optionally, the inner portion 148 can be a curved section of the cross-sectional profile 142.

In the depicted example, the orbital portion 141 defines an outer portion 144. The outer portion 144 is the portion of the cross-sectional profile 142 that is opposite to the opening 116 defined by the frame body 112. Similar to the inner portion 148, the outer portion 144 extends away from the lip portion 114. As illustrated, the outer portion 144 is a curved section of the cross-sectional profile 142. Similarly, the curvature of the outer portion 144 of the cross-sectional profile 142 can be referred to as outer curvature, which is distinguished from the frame curvature that is shown with respect to the x-y, x-z, and y-z planes. The outer portion 144 can be an arc or portion of a circular curve having a radius r3. In the depicted example, the radius r3 of the outer portion 144 is different than the radius r1 of the outer portion 124 and the radius r2 of the outer portion 134. In some embodiments, the radius r3 of the outer portion 144 is smaller than the radius r1 of the outer portion 124. Further, in some embodiments, the radius r3 of the outer portion 144 is larger than the radius r2 of the outer portion 134. In some embodiments, the outer portion 144 can include or define a simple curve, a compound curve, a transitional curve, and/or a reverse curve. In some embodiments, the curvature of the outer portion 144 is different than the curvature of the outer portion 124 and/or the curvature of the outer portion 134.

As illustrated, the various portions of the cross-sectional profile 142 can define an overall shape for the cross-sectional profile 142 that corresponds to the user's cheeks or orbital area. The overall shape of the cross-sectional profile 142 can be different than the overall shape of the cross-sectional profile 122 and/or cross-sectional profile 132. The cross-sectional profile 142 can have a defined area a3. In the depicted example, the area a3 of the cross-sectional profile 142 is different than the area a1 of the cross-sectional profile 122 and/or the area a2 of the cross-sectional profile 132. For example, the area a3 of the cross-sectional profile 142 is smaller than the area a1 of the cross-sectional profile 122. Further, in some embodiments, the area a3 of the cross-sectional profile 142 is larger than the area a2 of the cross-sectional profile 132.

As described in the examples provided herein, various portions of the frame body 112 can have different cross-sectional profiles, with different shapes, areas, and/or curvatures. In some embodiments, the frame body 112 can continuously vary in cross-sectional profile along various portions of the frame body 112. As used herein, a frame body continuously varies in cross-sectional profile when no portion thereof maintains a constant cross-sectional profile (e.g., dimension, diameter, thickness, width, etc.) along a length thereof. For example, the frame body 112 can smoothly transition with no intermediate “steps” or discontinuities between the different cross-sectional profiles. For example, the frame body 112 can smoothly transition between the cross-sectional profile 122 of the brow portion 121, the cross-sectional profile 132 of the bridge portion 131, and/or the cross-sectional profile 142 of the orbital portion 141.

In some embodiments, a specialized cutting tool can be utilized to machine the frame body 112 to provide smooth transitions between the different cross-sectional profiles. Optionally, the cutting tool can include a cutting surface with a varying radius. During a cutting operation, the orientation of the cutting surface can be continuously varied along the cutting path to machine the frame body 112 with varying radii of the cutting tool to provide a smooth transition between the different cross-sectional profiles and the different curvatures of the cross-sectional profiles.

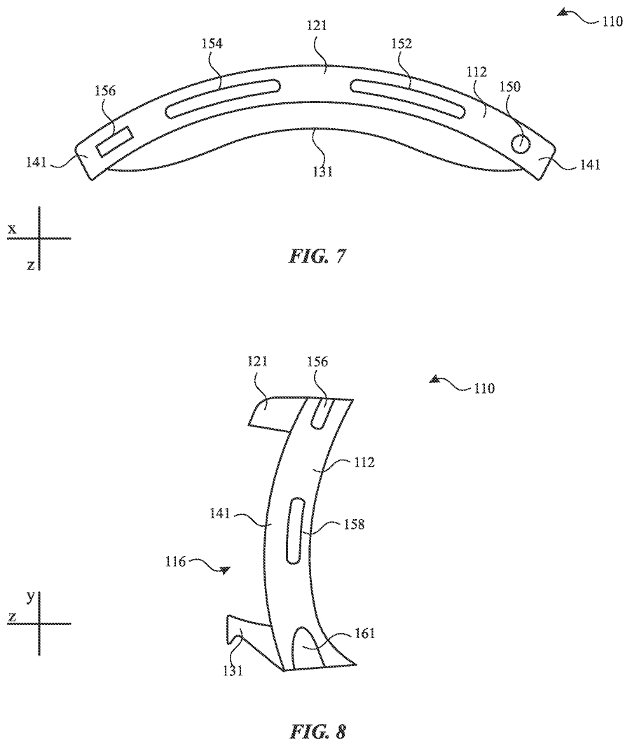

With reference to FIG. 7, a view of the frame 110 in the x-z plane is shown. As illustrated, the frame body 112 is curved or otherwise shaped in the x-z plane to allow for the frame 110 to conform to the shape of the user's face. In other words, the frame body 112 (instead of the cross-sectional profile of the frame body 112) can have frame curvature in the x-z plane. In the depicted example, the frame body 112 forms an arc or “C” shape in the x-z plane defining an outer curve and an inner curve in the x-z plane. In the depicted example, the orbital portions 141 of the frame body 112 are at the base of the arc while the brow portion 121 and/or the bridge portion 131 of the frame body 112 are toward the center or peak of the arc. In some embodiments, the brow portion 121 and/or the bridge portion 131 of the frame body 112 are positioned advanced or forward in the x-z plane relative to the orbital portions 141. The arc in the x-z plane can be configured to generally correspond to the position of the user's eyes. The arc of the frame body 112 can allow the displays 140 to be aligned with the user's eyes and can correspond to the curvature of the user's head in the x-z plane.

With reference to FIG. 8, a view of the frame 110 in the y-z plane is shown. As illustrated, the frame body 112 is curved or otherwise shaped in the y-z plane to allow for the frame 110 to conform to the shape of the user's face. In other words, the frame body 112 (instead of the cross-sectional profile of the frame body 112) can have frame curvature in the y-z plane. In the depicted example, the frame body 112 forms an arc or “C” shape in the y-z plane defining an outer curve and an inner curve in the y-z plane. In the depicted example, the brow portion 121 and the bridge portion 131 of the frame body 112 are at the bases of the arc while the center portion of the frame body 112 are toward the center or peak of the arc. In some embodiments, the brow portion 121 and/or the bridge portion 131 of the frame body 112 are positioned behind in the y-z plane relative to the central portion of the frame body 112. The arc in the y-z plane can be configured to generally correspond to the position of the user's eyes. The arc of the frame body 112 can allow the displays 140 to be aligned with the user's eyes y.

With reference to FIGS. 3 and 7-9, the frame 110 (instead of the cross-sectional profile of the frame body 112) can be curved in the x-y plane, the x-z plane, and the y-z plane. As illustrated, x-y plane, the x-z plane, and the y-z plane are perpendicular with each other. Advantageously, the frame 110 can be curved in multiple planes to allow for a frame 110 that is ergonomic and aesthetically pleasing to the user.

In the depicted example, due to the curvature of the frame body 112 in multiple planes, the outer surface of the frame body 112 can be a non-developable surface that cannot be formed by a curve in a single plane. In other words, the outer surface of the frame body 112 cannot be flattened into a plane without distortion. A non-developable surface may be referred to having double-curvature, compound curvature, and/or non-zero Gaussian curvature. In some embodiment, the non-developable surface of the frame body 112 can add strength to the frame 110. In some applications, forming a frame body with a non-developable surface may require time consuming machining processes that require multiple machining passes.

In some embodiments, a specialized cutting tool can be utilized to machine the frame body 112 to provide frame curvature in three perpendicular planes (e.g. x-y, x-z, and y-z) to provide a non-developable surface without requiring multiple passes of a cutting tool. As described herein, the cutting tool can include a cutting surface with a varying radius. During a cutting operation, the orientation of the cutting surface can be continuously varied along the cutting path to machine the frame body 112 with varying radii of the cutting tool to provide a curvature in multiple planes defining a non-developable surface on an outer surface of the frame 110. Advantageously, the processes described herein can be utilized to form a frame 110 for a head-mountable device that is monolithic in construction. The frame 110 can be formed from a metal or metal alloy.

Further, as illustrated, the frame 110 can include one or more slots or openings 150, 152, 154, 156, 158, 161. The openings 150, 152, 154, 156, 158, 161 can allow buttons or other controls of the head-mountable device to be accessed or manipulated through the frame 110. Further, certain slots or openings 150, 152, 154, 156, 158, 161 can allow for ventilation or attachment of other components. For example, the openings 158 can allow for the head engager 102 to be attached to the frame 110. The openings 150, 152, 154, 156, 158, 161 can be formed or defined during the machining process.

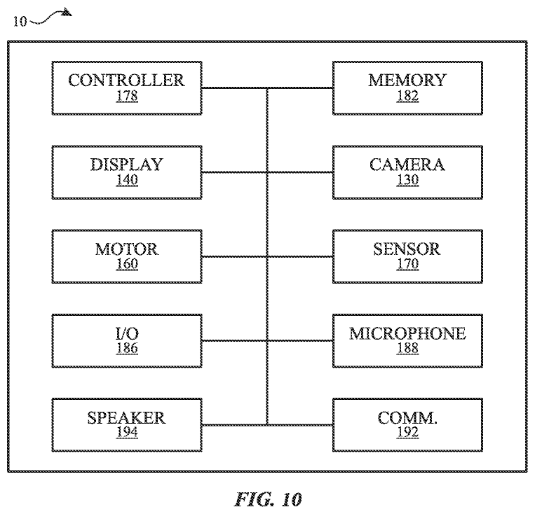

Referring now to FIG. 10, components of the head-mountable device can be operably connected to provide the performance described herein. FIG. 10 shows a simplified block diagram of an illustrative head-mountable device 10 in accordance with one embodiment of the invention. It will be appreciated that components described herein can be provided on one, some, or all of an HMD assembly, a light seal assembly, a nosepiece, and/or a support element. It will be understood that additional components, different components, or fewer components than those illustrated may be utilized within the scope of the subject disclosure.

As shown in FIG. 10, the head-mountable device 10 can include a controller 178 (e.g., control circuitry) with one or more processing units that include or are configured to access a memory 182 having instructions stored thereon. The instructions or computer programs may be configured to perform one or more of the operations or functions described with respect to the head-mountable device 10. The controller 178 can be implemented as any electronic device capable of processing, receiving, or transmitting data or instructions. For example, the controller 178 may include one or more of: a microprocessor, a central processing unit (CPU), an application-specific integrated circuit (ASIC), a digital signal processor (DSP), or combinations of such devices. As described herein, the term “processor” is meant to encompass a single processor or processing unit, multiple processors, multiple processing units, or other suitably configured computing element or elements.

The memory 182 can store electronic data that can be used by the head-mountable device 10. For example, the memory 182 can store electrical data or content such as, for example, audio and video files, documents and applications, device settings and user preferences, timing and control signals or data for the various modules, data structures or databases, and so on. The memory 182 can be configured as any type of memory. By way of example only, the memory 182 can be implemented as random access memory, read-only memory, Flash memory, removable memory, or other types of storage elements, or combinations of such devices.

The head-mountable device 10 can further include a display 140 for displaying visual information for a user. The display 140 can provide visual (e.g., image or video) output. The display 140 can be or include an opaque, transparent, and/or translucent display. The display 140 may have a transparent or translucent medium through which light representative of images is directed to a user's eyes. The display 140 may utilize digital light projection, OLEDS, LEDS, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. The head-mountable device 10 can include an optical subassembly configured to help optically adjust and correctly project the image-based content being displayed by the display 140 for close up viewing. The optical subassembly can include one or more lenses, mirrors, or other optical devices.

The head-mountable device 10 can include adjustment control components described herein, such as a motor 160, an actuator, and the like for moving components to a desired relative position and/or orientation.

The head-mountable device 10 can include one or more sensors 170, as described herein. The head-mountable device 10 can include one or more other sensors. Such sensors can be configured to sense substantially any type of characteristic such as, but not limited to, images, pressure, light, touch, force, temperature, position, motion, and so on. For example, the sensor can be a photodetector, a temperature sensor, a light or optical sensor, an atmospheric pressure sensor, a humidity sensor, a magnet, a gyroscope, an accelerometer, a chemical sensor, an ozone sensor, a particulate count sensor, and so on. By further example, the sensor can be a bio-sensor for tracking biometric characteristics, such as health and activity metrics. Other user sensors can perform facial feature detection, facial movement detection, facial recognition, eye tracking, user mood detection, user emotion detection, voice detection, etc. Sensors can include a camera which can capture image based content of the outside world.

The head-mountable device 10 can include an input/output component 186, which can include any suitable component for connecting head-mountable device 10 to other devices. Suitable components can include, for example, audio/video jacks, data connectors, or any additional or alternative input/output components. The input/output component 186 can include buttons, keys, or another feature that can act as a keyboard for operation by the user.

The head-mountable device 10 can include the microphone 188 as described herein. The microphone 188 can be operably connected to the controller 178 for detection of sound levels and communication of detections for further processing, as described further herein.

The head-mountable device 10 can include the speakers 190 as described herein. The speakers 194 can be operably connected to the controller 178 for control of speaker output, including sound levels, as described further herein.

The head-mountable device 10 can include communications circuitry 192 for communicating with one or more servers or other devices using any suitable communications protocol. For example, communications circuitry 192 can support Wi-Fi (e.g., a 802.11 protocol), Ethernet, Bluetooth, high frequency systems (e.g., 900 MHz, 2.4 GHz, and 5.6 GHz communication systems), infrared, TCP/IP (e.g., any of the protocols used in each of the TCP/IP layers), HTTP, BitTorrent, FTP, RTP, RTSP, SSH, any other communications protocol, or any combination thereof. Communications circuitry 192 can also include an antenna for transmitting and receiving electromagnetic signals.

The head-mountable device 10 can include a battery, which can charge and/or power components of the head-mountable device 10. The battery can also charge and/or power components connected to the head-mountable device 10.

Accordingly, embodiments of the present disclosure can provide a frame that supports components of a head-mountable device. The frame can include a frame body that is curved to fit a user's face. The frame body can include a forehead body portion, an orbital portion, and a bridge portion. Each body portion can have a cross-sectional profile that has an outer curvature. The outer curvature of each of the cross-sectional profiles can be different. Further, the frame body can transition in profile between the different cross-sectional profiles.

Various examples of aspects of the disclosure are described below as clauses for convenience. These are provided as examples, and do not limit the subject technology.
Clause A: a head-mountable device comprising: a display; and a frame to support the display, the frame comprising: a monolithic frame body curved to fit a user's face and defining a frame opening, the frame body comprising: a forehead body portion with a first cross-sectional profile having a first outer curvature; an orbital portion with a second cross-sectional profile having a second outer curvature; and a bridge portion with a third cross-sectional profile having a third outer curvature, wherein the frame body transitions in profile between the first cross-sectional profile, the second cross-sectional profile, and the third cross-sectional profile, and the first outer curvature, the second outer curvature, and the third outer curvature are each different.
Clause B: a head-mountable device comprising: a display; and a frame to support the display, the frame comprising: a frame body curved to fit a user's face and defining a frame opening, wherein the frame body transitions between a first cross-sectional profile having a first curvature at a first location, a second cross-sectional profile having a second curvature different from the from the first curvature at a second location spaced apart from the first location, and a third cross-sectional profile having a third curvature different from the first curvature and the second curvature at a third location spaced apart from the first location and the second location.
Clause C: a head-mountable device comprising: a display; and a frame to support the display, the frame comprising: a frame body curved to fit a user's face and defining a frame opening, the frame body comprising: a first body portion with a first cross-sectional profile; and a second body portion with a second cross-sectional profile, wherein the frame body transitions in profile between the first cross-sectional profile and the second cross-sectional profile, wherein the frame body defines a first frame curvature in a first plane, a second frame curvature in a second plane perpendicular to the first plane, and a third frame curvature in a third plane perpendicular to both the first plane and the second plane.

One or more of the above clauses can include one or more of the features described below. It is noted that any of the following clauses may be combined in any combination with each other, and placed into a respective independent clause, e.g., clause A, B, or C.
Clause 1: the head-mountable device further comprising a processor configured to provide a visual output signal to the display, wherein the processor is supported by the frame; a speaker supported by the frame and configured to receive an audio output signal from the processor; a microphone supported by the frame and configured to provide an audio input signal to the processor; and a camera supported by the frame and configured to provide a visual input signal to the processor.
Clause 2: a radius of the first outer curvature, the second outer curvature, and the third outer curvature are each different.
Clause 3: an area of the first cross-sectional profile, the second cross-sectional profile, and the third cross-sectional profile are each different.
Clause 4: the frame body includes a lip portion extending inwardly toward the frame opening.
Clause 5: the first location of the frame body is configured to engage a forehead of the user.
Clause 6: the second location of the frame body is configured to engage an orbital portion of the user.
Clause 7: the third location of the frame body is configured to engage a bridge of the user.
Clause 8: the frame body is monolithic.
Clause 9: the frame body comprises a metal or a metal alloy.
Clause 10: the first cross-sectional profile defines a first cross-sectional profile curvature and the second cross-sectional profile defines a second cross-sectional profile curvature different than the first cross-sectional profile curvature.
Clause 11: an area of the first cross-sectional profile and the second cross-sectional profile are each different.

As described above, one aspect of the present technology may include the gathering and use of data. The present disclosure contemplates that in some instances, this gathered data may include personal information or other data that uniquely identifies or can be used to locate or contact a specific person. The present disclosure contemplates that the entities responsible for the collection, disclosure, analysis, storage, transfer, or other use of such personal information or other data will comply with well-established privacy policies and/or privacy practices. The present disclosure also contemplates embodiments in which users can selectively block the use of or access to personal information or other data (e.g., managed to minimize risks of unintentional or unauthorized access or use).

A reference to an element in the singular is not intended to mean one and only one unless specifically so stated, but rather one or more. For example, “a” module may refer to one or more modules. An element proceeded by “a,” “an,” “the,” or “said” does not, without further constraints, preclude the existence of additional same elements.

Headings and subheadings, if any, are used for convenience only and do not limit the invention. The word exemplary is used to mean serving as an example or illustration. To the extent that the term include, have, or the like is used, such term is intended to be inclusive in a manner similar to the term comprise as comprise is interpreted when employed as a transitional word in a claim. Relational terms such as first and second and the like may be used to distinguish one entity or action from another without necessarily requiring or implying any actual such relationship or order between such entities or actions.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A phrase “at least one of” preceding a series of items, with the terms “and” or “or” to separate any of the items, modifies the list as a whole, rather than each member of the list. The phrase “at least one of” does not require selection of at least one item; rather, the phrase allows a meaning that includes at least one of any one of the items, and/or at least one of any combination of the items, and/or at least one of each of the items. By way of example, each of the phrases “at least one of A, B, and C” or “at least one of A, B, or C” refers to only A, only B, or only C; any combination of A, B, and C; and/or at least one of each of A, B, and C.

It is understood that the specific order or hierarchy of steps, operations, or processes disclosed is an illustration of exemplary approaches. Unless explicitly stated otherwise, it is understood that the specific order or hierarchy of steps, operations, or processes may be performed in different order. Some of the steps, operations, or processes may be performed simultaneously. The accompanying method claims, if any, present elements of the various steps, operations or processes in a Sample order, and are not meant to be limited to the specific order or hierarchy presented. These may be performed in serial, linearly, in parallel or in different order. It should be understood that the described instructions, operations, and systems can generally be integrated together in a single software/hardware product or packaged into multiple software/hardware products.

In one aspect, a term coupled or the like may refer to being directly coupled. In another aspect, a term coupled or the like may refer to being indirectly coupled.

Terms such as top, bottom, front, rear, side, horizontal, vertical, and the like refer to an arbitrary frame of reference, rather than to the ordinary gravitational frame of reference. Thus, such a term may extend upwardly, downwardly, diagonally, or horizontally in a gravitational frame of reference.

The disclosure is provided to enable any person skilled in the art to practice the various aspects described herein. In some instances, well-known structures and components are shown in block diagram form in order to avoid obscuring the concepts of the subject technology. The disclosure provides various examples of the subject technology, and the subject technology is not limited to these examples. Various modifications to these aspects will be readily apparent to those skilled in the art, and the principles described herein may be applied to other aspects.

All structural and functional equivalents to the elements of the various aspects described throughout the disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. $112, sixth paragraph, unless the element is expressly recited using the phrase “means for” or, in the case of a method claim, the element is recited using the phrase “step for”.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the claims. In addition, in the detailed description, it can be seen that the description provides illustrative examples and the various features are grouped together in various implementations for the purpose of streamlining the disclosure. The method of disclosure is not to be interpreted as reflecting an intention that the claimed subject matter requires more features than are expressly recited in each claim. Rather, as the claims reflect, inventive subject matter lies in less than all features of a single disclosed configuration or operation. The claims are hereby incorporated into the detailed description, with each claim standing on its own as a separately claimed subject matter.

The claims are not intended to be limited to the aspects described herein, but are to be accorded the full scope consistent with the language of the claims and to encompass all legal equivalents. Notwithstanding, none of the claims are intended to embrace subject matter that fails to satisfy the requirements of the applicable patent law, nor should they be interpreted in such a way.

What is claimed is:

1. A head-mountable device comprising:
a display; and
a frame to support the display, the frame comprising a monolithic frame body curved to fit a face and defining a frame opening, the frame body comprising:
a forehead body portion with a first cross-sectional profile having a first outer curvature;
an orbital portion with a second cross-sectional profile having a second outer curvature; and
a bridge portion with a third cross-sectional profile having a third outer curvature, wherein the frame body transitions in profile between the first cross-sectional profile, the second cross-sectional profile, and the third cross-sectional profile, and the first outer curvature, the second outer curvature, and the third outer curvature are each different.

2. The head-mountable device of claim 1, further comprising:
a processor configured to provide a visual output signal to the display, wherein the processor is supported by the frame;
a speaker supported by the frame and configured to receive an audio output signal from the processor;
a microphone supported by the frame and configured to provide an audio input signal to the processor; and
a camera supported by the frame and configured to provide a visual input signal to the processor.

3. The head-mountable device of claim 1, wherein a radius of the first outer curvature, the second outer curvature, and the third outer curvature are each different.

4. The head-mountable device of claim 1, wherein an area of the first cross-sectional profile, the second cross-sectional profile, and the third cross-sectional profile are each different.

5. The head-mountable device of claim 1, wherein the frame body includes a lip portion extending inwardly toward the frame opening.

6. The head-mountable device of claim 1, wherein:
the orbital portion is a first orbital portion;
the bridge portion is a first bridge portion; and
the frame body further comprises:
a second orbital portion; and
a second first bridge portion, wherein each of the first orbital portion and the second orbital portion extend from a corresponding one of the first bridge portion and the second bridge portion.

7. The head-mountable device of claim 6, wherein the forehead portion extends between the first orbital portion and the second orbital portion.

8. A head-mountable device comprising:
a display; and
a frame to support the display, the frame comprising:
a frame body curved to fit a face and defining a frame opening, wherein the frame body continuously transitions between a first cross-sectional profile having a first curvature at a first location, a second cross-sectional profile having a second curvature different from the from the first curvature at a second location spaced apart from the first location, and a third cross-sectional profile having a third curvature different from the first curvature and the second curvature at a third location spaced apart from the first location and the second location.

9. The head-mountable device of claim 8, wherein an area of the first cross-sectional profile, the second cross-sectional profile, and the third cross-sectional profile are each different.

10. The head-mountable device of claim 8, wherein the first location of the frame body is configured to engage a forehead.

11. The head-mountable device of claim 8, wherein the second location of the frame body is configured to engage an orbit of a head.

12. The head-mountable device of claim 8, wherein the third location of the frame body is configured to engage a nose bridge.

13. The head-mountable device of claim 8, wherein the frame body is monolithic.

14. The head-mountable device of claim 8, wherein the frame body comprises a metal or a metal alloy.

15. A head-mountable device comprising:
a display; and
a frame to support the display, the frame comprising a frame body curved to fit a face and defining a frame opening, the frame body comprising:
a first body portion with a first cross-sectional profile; and
a second body portion with a second cross-sectional profile, wherein the frame body continuously transitions in profile between the first cross-sectional profile and the second cross-sectional profile, wherein the frame body defines a first frame curvature in a first plane, a second frame curvature in a second plane perpendicular to the first plane, and a third frame curvature in a third plane perpendicular to both the first plane and the second plane.

16. The head-mountable device of claim 15, wherein the first cross-sectional profile defines a first cross-sectional profile curvature and the second cross-sectional profile defines a second cross-sectional profile curvature different than the first cross-sectional profile curvature.

17. The head-mountable device of claim 15, wherein an area f the first cross-sectional profile and the second cross-sectional profile are each different.

18. The head-mountable device of claim 15, wherein the first body portion is configured to engage a forehead, the second body portion is configured to engage an orbital portion, and the second body portion is configured to engage a nose bridge.

19. The head-mountable device of claim 15, wherein the frame body is monolithic.

20. The head-mountable device of claim 15, wherein the frame body comprises a metal or a metal alloy.
